(19) United States
(12) Patent Application Publication
(10) Pub. No.: US 2017/0297713 A1
(43) Pub. Date: Oct. 19, 2017

(54) Vehicle Body and Method for Assembling a Vehicle Body

(71) Applicant: Airbus Operations GmbH, Hamburg (DE)

(72) Inventors: Matthias Hegenbart, Hamburg (DE); Detlev Konigorski, Hamburg (DE); Peter Linde, Hamburg (DE)

(73) Assignee: Airbus Operations GmbH, Hamburg (DE)

(21) Appl. No.: 15/407,510

(22) Filed: Jan. 17, 2017

(30) Foreign Application Priority Data
Jan. 18, 2016 (DE) 102016100750.1

(51) Int. Cl. B64D 11/00; E01D 19/04; B64F 5/00; B64D 11/06; B64C 1/40; E04B 1/61; B64C 1/18; B64D 11/02; B64C 1/06

(52) U.S. Cl. CPC B64D 11/00; E04B 1/54; E01D 19/04; B64F 5/00; B64D 11/0696; B64C 1/18; B64C 1/40; B64D 11/003; B64D 11/02; B64C 1/066; B64D 2011/0046

(57) ABSTRACT

A vehicle body includes a primary vehicle structure and interior vehicle fittings as well as a coupling device for fastening the interior vehicle fittings to the primary vehicle structure. The coupling device is configured to generate a magnetic field, so as to fasten the interior vehicle fittings to the primary vehicle structure without contact. Methods for assembling a vehicle body as well as an edifice are also described.

### FIELD OF THE INVENTION

The present invention relates to the fastening of structural elements in vehicle bodies. In particular, the invention relates to a vehicle body, a method for assembling a vehicle body and an edifice.

### BACKGROUND OF THE INVENTION

In order to reduce impact loads in vehicles, use is today made of fasteners that fasten specific structural elements inside of the vehicle body or vehicle hull. Such fasteners reduce the transmission of impact loads, accelerations and vibrations inside of the vehicle. For example, such fasteners are used to fasten structural elements to the vehicle body, as a result of which external impact loads that act on the vehicle body are transmitted to the passengers or structural components located inside of the vehicle to a diminished extent, i.e. dampened. Such structural components include passenger seats, upon which the passengers are located, as well as other components in the vehicle cabin. The fasteners required to diminish the impact load are placed in large numbers inside of the vehicle body, so as to cushion the components of the cabin located inside of the body, such as passenger seats, against the outside environment. In particular, this requires a large number of fasteners, which can give rise to high costs, a high weight, a large installation requirement along with a major development and certification requirement.

EP 2 905 225 A1 describes a fastening structure for an equipment unit of an aircraft. The fastening structure comprises a first fastening device, which extends in a longitudinal direction and is fastened to a stringer and a frame/rib. The first fastening device comprises a first engaging element and a second fastening device, which can be fastened to the equipment unit.

DE 10 2011 114 098 A1 describes a fastening device for fastening components to a fastening structure of a transport means, in particular of an airplane. The fastening device exhibits a clamping device and an actuator connected to the clamping device for actuating the clamping device. Such fastening structures can also be provided in buildings in order to fasten interior devices to load-bearing structures. These fastening structures often transmit disruptive vibrations as well.

### BRIEF SUMMARY OF THE INVENTION

An aspect of the invention may increase the comfort of the users of a vehicle or building.

According to one aspect of the invention, a vehicle body is provided. The vehicle body comprises a primary vehicle structure, interior vehicle fittings and a coupling device for fastening the interior vehicle fittings to the primary vehicle structure. The coupling device is configured to generate a magnetic field, so as to fasten the interior vehicle fittings to the primary vehicle structure without contact.

Such a vehicle body makes it possible to transmit impact loads, which act on the vehicle body, to interior vehicle fitting components, e.g. floor structures, storage compartments, ceiling or side wall panels, to a diminished extent, i.e. dampened.

For example, the vehicle body is a body of a vehicle, in particular of an aircraft. The vehicle body according to an embodiment of the invention further makes it possible to weaken the transmission of vibration loads acting on the vehicle, e.g. through its drive system, to the interior vehicle fittings. As a consequence, the comfort for passengers located inside of the vehicle body can be improved. Apart from the improved comfort, the weight of the vehicle body can also be reduced. The vehicle body further makes it possible to diminish, dampen or entirely avoid the transmission of vibrations and noises, in particular structure-born sound.

For example, the primary vehicle structure comprises body parts or outer skin parts of the vehicle body. The primary vehicle structure can further also comprise frames and stringers along with other stiffening elements, which constitute the basic structure of the vehicle body. The interior vehicle fittings can comprise vehicle cabin elements, such as floor structures, passenger seats, storage compartments, side wall and ceiling panels. The coupling device can be configured in such a way that the magnetic field decouples the interior vehicle fittings from the primary vehicle structure. In other words, it can be provided that the interior vehicle fittings are not in direct contact with the primary vehicle structure by keeping the interior vehicle fittings in a suspended state in relation to the primary vehicle structure. As a result of this suspended state, there is at least an air gap or distance between the primary vehicle structure and interior vehicle fittings, by way of which impact loads acting on the vehicle body can be cushioned by the magnetic field. For example, if the vehicle body is deflected out of a specific position by an impact load, e.g. by the drive system or an external force, the acceleration produced by the deflection does not directly impact the interior vehicle fittings, but is rather transmitted to the interior vehicle fittings delayed and dampened. For example, since the passenger seats are directly joined with the interior vehicle fittings, the impact loads on the vehicle body can thus be transmitted in a dampened fashion to the passengers located in the vehicle body, thereby making it possible to increase passenger comfort. The magnetic field is here aligned in such a way that the interior vehicle fittings are decoupled and repelled from the primary vehicle structure in all spatial directions. As a result, an air gap can be provided between the interior vehicle fittings and the primary vehicle structure, so that the air gap remains constant once the position of the interior vehicle fittings has reached a stable equilibrium relative to the primary vehicle structure.

For example, a floor structure of the vehicle body is kept in a suspended state in relation to the primary vehicle structure, which at last partially forms the vehicle body. The interior vehicle fittings can thus be kept in position relative to the primary vehicle structure without any contact. For example, this can be achieved by aligning the magnetic field in such a way that the interior vehicle fittings are held in position relative to the primary vehicle structure in all spatial directions, with there not being any direct structural contact between the interior vehicle fittings and primary vehicle structure.

According to an embodiment of the invention, the coupling device comprises a magnet and a superconducting material, wherein the magnet and superconducting material are designed to keep the interior vehicle fittings in a suspended state relative to the primary vehicle structure.

The suspended state can ensure a dampened transmission of impact loads or vibrations. Correspondingly arranging the magnets and superconducting material makes it possible to ensure a stable state of equilibrium for the position of the interior vehicle fittings relative to the primary vehicle structure, and hence inside of the vehicle body. This stable state of equilibrium, which is provided by a correspondingly aligned magnetic field, can be referred to as a so-called frozen-flux, for example. In other words, the interior vehicle fittings inside of the primary vehicle structure or inside of the vehicle body assume a specific position as the result of a corresponding alignment of the magnetic field. Any impact loads or vibrations can be transmitted from the primary vehicle structure or vehicle body to the interior vehicle fittings either delayed and dampened, respectively. It can be provided that a direct contact between the primary vehicle structure and interior vehicle fittings be avoided, even given strong impact loads on the vehicle body. To this end, for example, the strength of the magnetic field can be set via the coupling device. It is possible for part of the coupling device to be fastened to the primary vehicle structure, wherein another part of the coupling device is fastened to the interior vehicle fittings.

In a further embodiment of the invention, the magnet is mounted to the primary vehicle structure, and/or the superconducting material is mounted to the interior vehicle fittings.

For example, the superconducting material can be fastened to the interior vehicle fittings in the form of a superconductor. A superconductor is a material whose electrical resistance drops to zero when the transition temperature is undercut. To this end, it can be provided that the superconductor or superconducting material is cooled to a cryogenic temperature range. However, it is also possible to use room temperature superconductors. In this case, for example, cooling can be omitted. By fastening the magnet to the primary vehicle structure and by fastening the superconducting material to the interior vehicle fittings, the magnetic field can be aligned in such a way as to hold the interior vehicle fittings in a suspended state relative to the primary vehicle structure. As a consequence, it is no longer necessary to fasten the interior vehicle fittings to the primary vehicle structure with fasteners, e.g. rivets or screws. This will be explained even more precisely in the description of the figures.

According to another embodiment of the invention, the coupling device comprises a plurality of magnets, which are arranged at prescribed distances parallel to a longitudinal axis of the vehicle body and which are fastened to the primary vehicle structure.

Accordingly, a plurality of superconducting materials or a plurality of superconductors can themselves be fastened to the interior vehicle fittings at prescribed distances parallel to the longitudinal axis of the vehicle body. The plurality of magnets or superconductors makes it possible to provide an exact positioning by way of the provided suspended state of the interior vehicle fittings relative to the primary vehicle structure. For example, the plurality of superconductors can be fastened to lateral edges of a floor structure. As a consequence, for example, the floor structure can be held or positioned in the suspended state relative to the vehicle body.

According to another embodiment of the invention, the coupling device exhibits a cooling unit, which is designed to cool at least a portion of the coupling device to a cryogenic temperature range.

For example, that portion of the coupling device exhibiting the superconducting material or superconductor is cooled to the cryogenic temperature ranges. The cooling unit can be arranged around the superconductor or wound around the latter, for example. A fluid, in particular a coolant, can flow through the cooling unit, for example. Cooling the superconductor or superconducting material makes it possible to significantly reduce the electrical resistance of the superconductor. This is especially advantageous, since the superconductor carries an electrical current. It is further possible for the cooling unit to exhibit a cryogen-free cooler, e.g. a cooler that functions without the use of a fluid.

The magnets can be permanent magnets, electromagnets, superconducting electromagnets and/or superconducting permanent magnets (frozen-flux permanent magnets).

Let it be noted that the magnet can be secured to the primary vehicle structure, and the superconducting material to the interior vehicle fittings. However, it is also possible to secure the magnet on the interior vehicle fittings and the superconducting material to the primary vehicle structure. Such a configuration also makes it possible to achieve a magnetic field, and hence the suspended state or contactless fastening of the interior vehicle fittings relative to the primary vehicle structure.

According to another embodiment of the invention, the interior vehicle fittings comprises a floor structure for receiving goods to be transported inside of the vehicle body.

For example, the floor structure is the floor structure of a passenger cabin of an aircraft. Passenger seats can be fastened to the floor structure, for example. As a consequence, passenger comfort can be improved by the suspended state of the floor structure relative to the primary structure of the aircraft body.

However, the interior vehicle fittings can also comprise other cabin components, for example storage compartments (overhead stowage compartments), along with trim panels, such as ceiling or side wall panels. The interior vehicle fittings can also comprise toilets, showers, washrooms, kitchens, storage cabinets, partitions, sleeping areas and freight or freight containers. In particular, the interior vehicle fittings can comprise various monuments of an airliner.

According to another embodiment of the invention, the coupling device is designed to position the interior vehicle fittings relative to the primary vehicle structure by controlling the magnetic field.

For example, it is possible to control the magnetic field with the coupling device in such a way as to set the attenuation or spring stiffness or magnetic field intensity. Let it here be understood that the term spring stiffness is here used synonymously for the strength or intensity of the magnetic field, since in particular a contactless fastening of the interior vehicle fittings to the primary vehicle structure is provided, so that no spring is used in the actual sense. In other words, then, the intensity of the magnetic field can be set similarly to a chassis shock absorber. The coupling device or a control device, for example one integrated into the coupling device, can provide for an active vibration damping. In particular, the coupling device can exhibit a corresponding adaptronic for this purpose.

In particular, the strength of the magnetic field can be set with regard to specific directions, i.e. spatial directions, so that forces acting on the interior vehicle fittings can vary in different spatial directions. In other words, a distance of an air gap between the interior vehicle fittings and the primary vehicle structure can be varied, and hence set. To this end, for example, the coupling device exhibits a control device, with which the magnetic field strength is set. In particular, controlling the magnetic field also makes it possible to actively displace the interior vehicle fittings relative to the primary vehicle structure. This can be advantageous in particular during assembly of the vehicle body, as will be explained more precisely below.

According to another embodiment of the invention, the coupling device is designed to transmit forces in a x-direction, in a y-direction and in a z-direction of the vehicle body.

As a result, the interior vehicle fittings can be clamped or fixedly positioned or fixed in place relative to the primary vehicle structure by means of the magnetic field, without any contact being required between the interior vehicle fittings and primary vehicle structure in the process. In other words, mounting the interior vehicle fittings without contact in relation to the primary vehicle structure provides a kind of floating/suspended bearing, wherein a relative displacement between the interior vehicle fittings and primary vehicle structure is limited, since the coupling device can transmit forces in any spatial direction. For example, the larger the positional deflection of the interior vehicle fittings relative to the primary vehicle structure, the stronger a restoring magnetic force can be, which brings the interior vehicle fittings back into a stable equilibrium position.

According to another embodiment of the invention, the vehicle body is an aircraft fuselage.

In particular, the aircraft fuselage is a fuselage of an airliner or transport plane. However, it is also possible for the vehicle body to be the fuselage of a spacecraft or helicopter. It can also be provided that the vehicle body be the body of a ground vehicle, for example of a passenger car or rail vehicle.

According to another aspect of the invention, a method for assembling a vehicle body is provided. In one step of the method, a primary vehicle structure and interior vehicle fittings are provided. In another step of the method, a coupling device is provided for generating a magnetic field. Another step further involves displacing the interior vehicle fittings relative to the primary vehicle structure along a longitudinal direction of the vehicle body to be mounted, wherein the interior vehicle fittings are guided by the magnetic field without contact during displacement along the primary vehicle structure.

For example, another step can involve fabricating the primary vehicle structure, wherein the primary vehicle structure exhibits frames, stringers and/or outer skin elements of the vehicle body, for example. In another step, the interior vehicle fittings can be at least partially prefabricated, wherein the interior vehicle fittings are introduced or inserted into the vehicle body as prefabricated component. The magnetic field can here be aligned in such a way that forces can only be transmitted in two spatial directions, wherein forces cannot be transmitted between the interior vehicle fittings and primary vehicle structure in the third spatial direction, so as to thereby enable the displacement of interior vehicle fittings relative to the primary vehicle structure. In other words, the interior vehicle fittings are inserted like a drawer into the primary vehicle structure or into the vehicle body to be installed. In another step, the contactless fastening of the interior vehicle fittings to the primary vehicle structure can then take place.

According to another aspect of the invention, an edifice with a load-bearing structure, interior fittings and a coupling device for fastening the interior fittings to the load-bearing structure is provided. The coupling device is designed to generate a magnetic field, so as to fasten the interior fittings to the load-bearing structure without contact.

The features described for the vehicle body can thus be applied to the edifice in the same or similar manner. In particular, the advantageous embodiments of the vehicle body can also be applied analogously to the edifice.

As a consequence, the advantageous characteristics associated with the contactless bearing or fastening of interior vehicle fitting elements inside of a passenger cabin of a vehicle can also be applied to static structures, such as edifices. For example, the edifice is a building, wherein the load-bearing structure exhibits a building scaffolding or building wall. For example, the interior fittings are a floor structure inside of the building, wherein the floor structure is fastened by the coupling device to a building wall or building scaffolding without contact.

Furthermore, stairs or an entire staircase can be fastened without contact by the coupling device to a building wall or building scaffolding. As a consequence, vibrations caused by people located or walking on the stairs can be cushioned, so that these vibrations are only partially transmitted to living spaces in the building, or not at all.

In addition, it is possible for the edifice to comprise a bridge as interior fittings. The bridge can here be fastened without contact by the coupling device to the load-bearing structure, which takes the form of bridge piers, or to the ends of the bridge.

The vehicle body according to an embodiment of the invention makes it possible to reduce costs, weight, installation outlay, and development and certification outlay by eliminating the need for fasteners, such as rivets or screw connections, for fastening the interior vehicle fittings to the primary vehicle structure. In particular, this fastening takes place without contact with the described coupling device. A lightweight building structure can thus be provided, which decouples the vehicle cabin from the vehicle body or primary structural elements of the vehicle body. In particular, the cabin floor can be decoupled from the vehicle body. Among other things, this makes it possible to also diminish the bending moments acting on the vehicle body or floor structure. Furthermore, this makes it possible to provide improved damping characteristics, in particular during impact loads. During impact loads, high accelerations are often encountered, which can be cushioned by the coupling device. The vehicle body according to the invention can hence be used to at least partially absorb impact loads and vibration loads, since there is no direct connection and thus no direct transmission of impact loads or vibration loads from the primary structure into the passenger cabin, and in particular into the floor structure of the passenger cabin. Advantageous effects of the vehicle body according to an embodiment of the invention include enhanced passenger comfort arising from reduced positional deflections caused by turbulence, reduced vibration loads and diminished noise. For example, it is possible to at least partially absorb or even entirely avoid structure-born noises caused by engines, systems, pumps, generators, chasses, turbulent flows as well as aerodynamics.

The magnetic field can be used to create a so-called frozen-flux state, which decouples the interior vehicle fittings and hence the vehicle cabin from the vehicle body or primary vehicle structure of the vehicle body. As a consequence, for example, the floor structure and additional cabin interior fitting elements can be decoupled from the primary vehicle structure.

For example, the superconductor can be fastened to a crossbeam of the floor structure, so that the crossbeam and hence the entire floor structure is held in the suspended state relative to the primary vehicle structure. For example, the crossbeam can be held in a suspended state inside of a bracket-shaped component, in which the magnets are arranged. The superconducting material exhibits a permanent magnet, an electromagnetic device or preferably a superconducting electromagnetic device, for example.

As a result, any form of vibration and impact load can be absorbed, since the floor structure is mounted in a contactless manner, i.e. without contact or suspended/floating, inside of the vehicle body and relative to the primary structure of the vehicle body, respectively. The so-called frozen-flux principle thus yields a contactless fastening of the superconductor. For example, the magnetic field is provided by a cryostat, which can be part of the cooling unit. The cryostat is a cooling device, with which very low temperatures can be reached and held constant. In particular, cryogenic temperature ranges can be provided.

For example, the vehicle body comprises a cabin floor with crossbeams, a control unit, in particular an electrical control unit, a measuring device, an aircraft floor, a bracket for positioning the magnets, a cryostat in the form of a cooling unit, in particular a cooling unit for using a coolant, a superconducting material as well as an adaptronic system for active damping. Controlling the magnetic field makes it possible to freely suspend/float the cabin floor relative to the primary vehicle structure, and hence the vehicle body. Furthermore, it is possible to position or align the cabin floor inside of the vehicle body. The free suspension and resultantly generated air gap allows impact loads and vibration loads to be absorbed. The adaptronic system makes it possible to achieve active accelerations and shock absorptions as well as a reduction in vibrations, so as to thereby increase passenger comfort, but also passenger safety.

In addition, bending moments can be diminished in stiffening elements, in particular frames and stringers, of the vehicle or aircraft by structurally decoupling the floor structure of the aircraft from the stiffening elements. As a consequence, the pressure acting on the aircraft fuselage inside of the latter can be uniformly transmitted to the fuselage structure, wherein the stiffening elements must no longer be fastened to the floor structure or cabin floor via direct fasteners, such as screws or riveted joints. Pure tensile forces can thereby act on the fuselage, and in particular on outer skin portions and stiffening elements of the fuselage. This makes it possible to achieve a reduced-weight design along with an improved fatigue strength for the stiffening elements. In addition, the assembly outlay can be diminished, since a large number of fasteners, which fasten the floor structure or crossbeam of the floor structure to the primary vehicle structure, no longer needs to be installed.

Furthermore, it is possible to insert the completely equipped cabin floor, including integrated systems and the entire cabin, into the vehicle body, and fix the latter in place relative to the primary vehicle structure. In this way, in particular the assembly time of an aircraft fuselage can be significantly reduced, since the floor structure of the aircraft fuselage, including the integrated systems, can be completely inserted into the aircraft fuselage like a drawer. Mounting the interior vehicle fittings inside of the primary vehicle structure without contact also makes it possible to avoid integrating frames inside of the vehicle body, thereby improving access in specific areas inside of the vehicle body, in particular during the installation and maintenance of specific systems. For example, the coupling device requires no mechanical fastening or connecting parts, thus making it possible to economize on weight and reduce the maintenance outlay.

### BRIEF DESCRIPTION OF DRAWINGS

FIG. 1 shows a vehicle body with a primary vehicle structure and interior vehicle fittings, which are fastened in the primary vehicle structure by a riveted connection.

FIG. 2 shows a bending moment progression of a primary vehicle structure and interior vehicle fittings.

FIG. 3 shows a vehicle body with a primary vehicle structure and interior vehicle fittings, which are fastened to the primary vehicle structure by a coupling device, according to an exemplary embodiment of the invention.

FIG. 4 shows a detailed view of the coupling device according to an exemplary embodiment of the invention.

FIG. 5 shows an arrangement of a magnet and a superconductor as well as a magnetic field according to an exemplary embodiment of the invention.

FIG. 6 shows a magnet and a superconductor as well as a magnetic field according to a further exemplary embodiment of the invention.

FIG. 7 shows an aircraft fuselage according to an exemplary embodiment of the invention.

FIG. 8 shows a flowchart for a method for assembling the vehicle body according to an exemplary embodiment of the invention.

### DETAILED DESCRIPTION

The illustrations in the figures are schematic and not to scale.

If the same reference numbers are used in the following description of the figures on different figures, they denote the same or similar elements. However, the same or similar elements can also be denoted by different reference numbers.

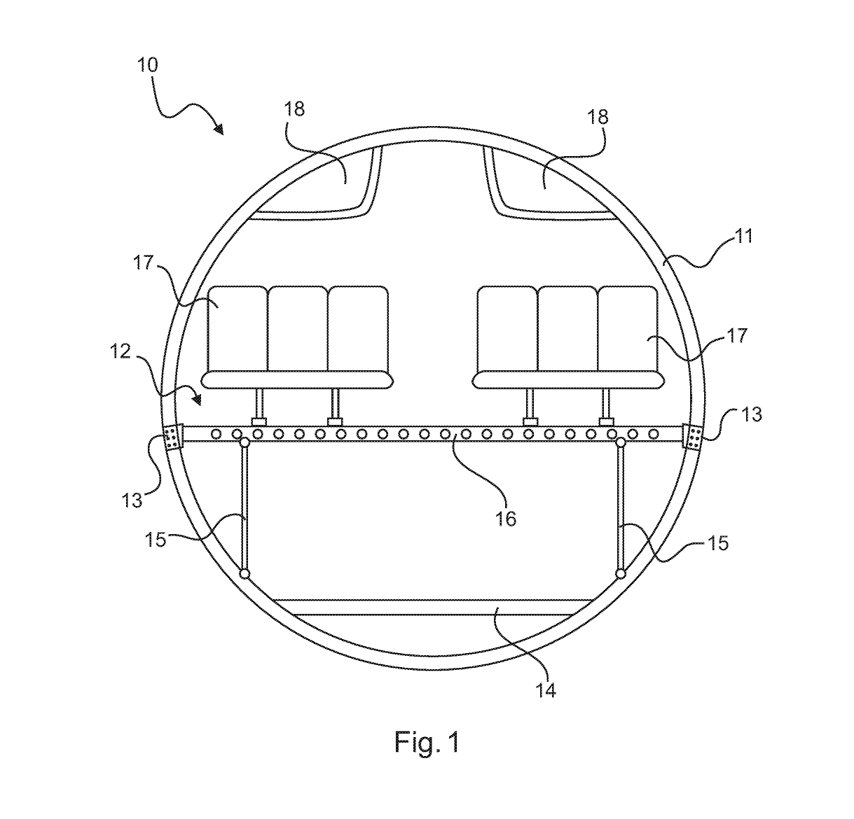

FIG. 1 shows a vehicle body 10, in particular an aircraft fuselage, with a primary vehicle structure 11 along with interior cabin fittings 12, which are fastened to the primary vehicle structure 11 by means of a fastening device 13, in particular a riveted connection or a screwed connection. For example, the interior vehicle fittings 12 comprise a floor structure 16, to which passenger seats 17 are fastened. The floor structure 16 can further be fastened to the primary vehicle structure 11 by frames 15 or stiffening elements. In addition, FIG. 1 exhibits another floor structure 14 of a cargo space. The vehicle body 10 further comprises interior cabin fitting elements 18, for example storage compartments or ceiling and side wall panels, wherein the interior cabin fitting elements 18 are fastened either to the primary vehicle structure 11 or interior cabin fittings 12.

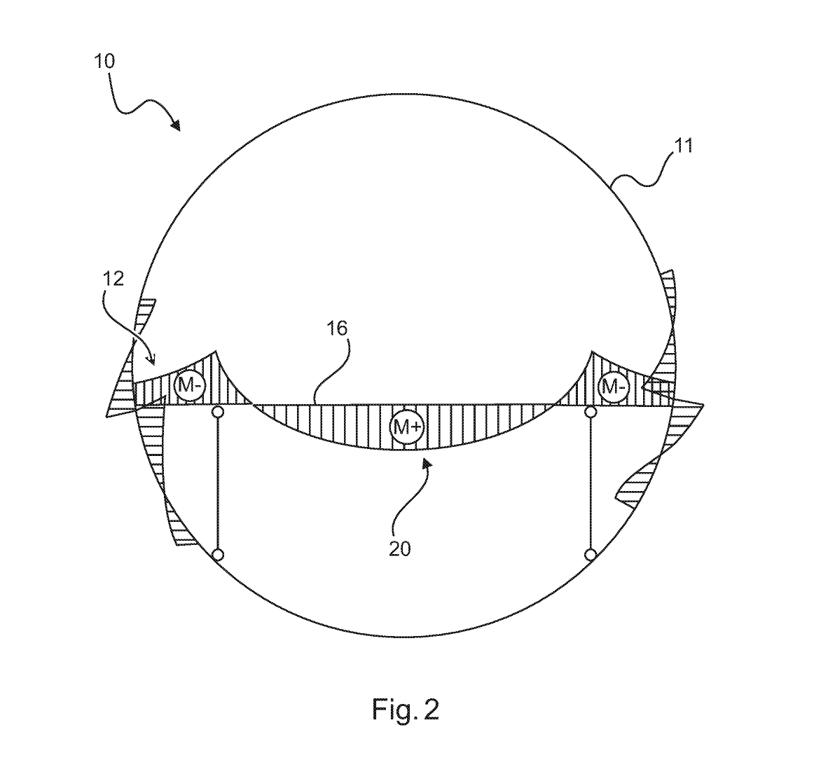

FIG. 2 shows a torque profile 20 for interior cabin fittings 12 and at least partially for a primary vehicle structure 11. In particular, FIG. 2 shows a torque profile 20 for a floor structure 16 inside of the vehicle body 10. The torque profile 20 depicted in FIG. 2 is here caused by directly fastening the floor structure 16 to the primary vehicle structure 11, since any loads that act on the floor structure 16 are transmitted directly into the primary vehicle structure 11. For example, this results in bending moments both in the floor structure 16 and in the primary vehicle structure 11, which exhibits frames, stringers or other stiffening elements of the vehicle body 10, for example.

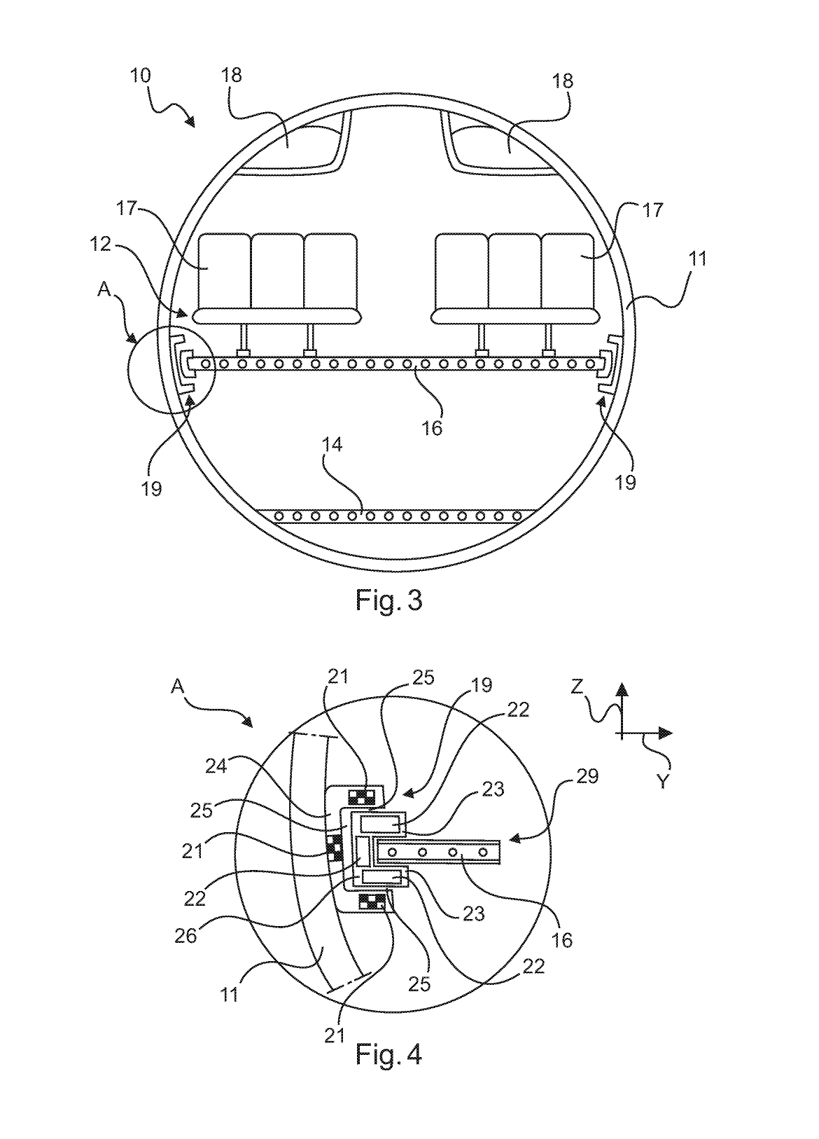

FIG. 3 shows a vehicle body 10, which exhibits a primary vehicle structure 11 and interior vehicle fittings 12, wherein the interior vehicle fittings 12 are fastened to the primary vehicle structure 11 by means of the coupling device 19. In particular, the interior vehicle fittings 12 comprises a floor structure 16 in the form of a cabin floor of a passenger cabin of an aircraft. Thus, for example, the vehicle body 10 is an aircraft fuselage of an airliner or transport plane. Apart from the floor structure 16, the vehicle body 10 comprises another floor structure 14 for a cargo space of the aircraft. The floor structure 14 of the cargo space can also be fastened to the primary vehicle structure 11 by means of one or more coupling devices 19. For example, passenger seats 17 are fastened to the floor structure 16 of the passenger cabin. The passenger seats 17 can be fastened in the floor structure 16 by means of seat rails, which are not shown on FIG. 3, for example.

The vehicle body 10 further comprises interior cabin fitting elements 18, which can be fastened either to the primary vehicle structure 11 or interior vehicle fittings 12. The coupling device 19 makes it possible to generate a magnetic field. The magnetic field is configured in such a way as to hold the floor structure 16 in a suspended state relative to the primary vehicle structure 11. In particular, the coupling device 19 is designed to generate the magnetic field, so as to thereby fasten the interior vehicle fittings 12 to the primary vehicle structure 11 without contact.

Mounting the interior vehicle fittings 12 in a contactless manner relative to the primary vehicle structure 11 makes it possible to provide a damping of impact loads acting on the vehicle body 10 and aircraft fuselage, respectively. Furthermore, vibrations and noises associated with the vehicle body 10 can be transmitted to a diminished extent, i.e., dampened, to the interior cabin fittings 12 and hence to the floor structure 16. As a result, the passenger comfort of passengers seated on the passenger seats 17 can be increased. In addition, mounting the interior vehicle fittings 12 in a contactless manner relative to the primary vehicle structure 11 makes it possible to improve or render more advantageous the bending moment profile in the respective components of the primary vehicle structure 11 and interior vehicle fittings 12. In particular, contactless mounting can prevent bending forces from the floor structure from being directly introduced into the primary vehicle structure 11. As a result, a more uniform distribution of pressure can be provided by the internal pressure on the primary structure 11 of the aircraft.

FIG. 4 shows a detailed view of the coupling device 19 of FIG. 3. The coupling device 19 exhibits a magnet 21, preferably three magnets 21, as well as a superconducting material in the form of a superconductor 22, preferably three superconductors 22. The magnets 21 are here arranged in a U-shaped profile 24 or a bracket-shaped part. As depicted on FIG. 4, a magnet 21 is respectively provided in the two legs of the U-profile 24, wherein a magnet 21 is provided in the web/link of the U-profile 24. The U-profile 24 or the bracket-shaped part, in which the magnets 21 are arranged, can be directly fastened to the primary structure 11. However, it is also possible for the magnets 21 to be fastened directly to the primary structure 11. The floor structure 16 also exhibits a U-shaped profile 26 at an edge, i.e., at an end of the floor structure 16. The U-shaped profile 26 of the floor structure 16 can here incorporate at least one superconductor 22, preferably three superconductors 22, as shown on FIG. 4. A superconductor 22 can here be situated respectively in the two legs of the U-shaped profile 26, and a superconductor 22 can be situated inside of the web/link of the U-shaped profile 26. For example, one end of the floor structure 16 can be introduced or inserted into the recess of the U-shaped profile 26. In other words, the U-shaped profile 26, in which the superconductors 22 are located, can be placed or fitted onto the floor structure 16. The generated magnetic field makes it possible to keep the floor structure 16 with the U-shaped profile 26 or with the superconductors 22 suspended in relation to the primary structure 11. In the suspended state, the U-shaped profile 26 of the floor structure 16 is optionally located in a recess of the U-shaped profile 24, in which the magnets 21 are situated. However, an air gap 25 is always present between the U-profile 26, floor structure 16 and U-profile 24, which is fastened to the primary structure 11, so that the floor structure 16 can be kept in a suspended state 29 relative to the primary structure 11, as a result of which the interior vehicle fittings 12 are fastened to the primary vehicle structure 11 without contact. As depicted in FIG. 4, three air gaps 25 can be provided by the suspended mounting. As a consequence, a floating support of the floor structure 16 or entire interior vehicle fittings is achieved relative to the primary vehicle structure 11 of the vehicle body 10. Also referred to as frozen-flux, this principle ensures a stable state of equilibrium for the relative position of the interior vehicle fittings 12 relative to the primary vehicle structure 11 inside of the vehicle body 10.

FIG. 4 shows a cooling unit 23, which is designed to cool at least a portion of the coupling device 19 to a cryogenic temperature range. In particular, the cooling unit 23 is designed to cool the superconductors 22 to a cryogenic temperature range. For example, the cooling unit 23 is arranged around the superconductors 22, so as to cool the latter. As a consequence, the cooling unit 23 can use a coolant to cool the superconductors 22, for example. The electrical resistance of the superconductors 22 can be significantly diminished by cooling.

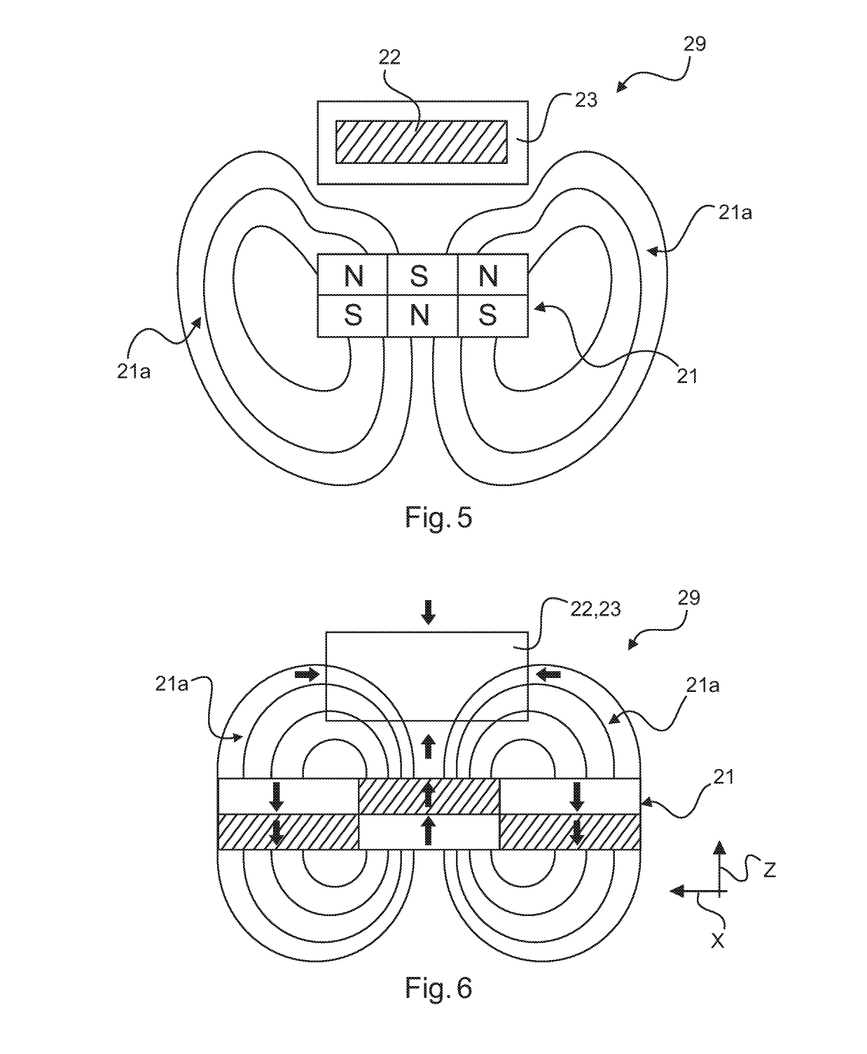

FIG. 5 shows the alignment or arrangement of a magnetic field 21a, wherein the magnetic field is generated by the magnet 21. For example, the magnet 21 can exhibit several partial magnets, which have a specific alignment of the north and south poles relative to each other, so as to provide the alignment of the magnetic field 21a depicted in FIG. 5. In particular, an irregularity or deviation of the magnetic field lines can be generated in the area of the superconductor 22 located in proximity to the magnet 21, so that forces act on the superconductor 22 in such a way that it can be held in a specific position. Thus, FIG. 5 illustrates a suspended state 29 of the superconductor 22, which is fastened to parts of the interior vehicle fittings 12 not shown on FIG. 5, in particular to the floor structure 16. FIG. 5 further depicts a stable state of equilibrium for the position of the superconductor 22 relative to the position of the magnet 21. Arranging several magnets 21 as shown in FIG. 4 makes it possible to achieve an exact positioning or alignment of the superconductor 22 and the floor structure 16 joined thereto. The superconductor 22 further exhibits a cooling unit 23, which is arranged around the superconductor 22 and is designed to conduct a cooling fluid, for example.

The forces acting on the superconductor 22 and the components of the interior vehicle fittings 12 connected thereto are denoted by arrows in FIG. 6. The magnetic field 12 provided by the magnet 21 or arrangement of partial magnets here exerts a force on the superconductor 22 in such a way that the latter can be kept in a stable state of equilibrium. In particular, this results in a suspended state 29 of the superconductor 22 relative to the magnet 21.

This in turn causes the interior vehicle fittings 12 to be held in the suspended state 29 as an overall component relative to the primary vehicle structure as an overall component, thereby ensuring a contactless mounting of the interior vehicle fittings 12 to the primary vehicle structure 11. In particular, the force exerted by the magnetic field 21a can prevent a displacement by the superconductor 22 relative to the magnet 21 in an x-direction, i.e., parallel to a longitudinal direction of the vehicle body 10 or aircraft fuselage, since a force can be transmitted in this x-direction. Analogously, a force can be provided in the z-direction, i.e., along a vertical axis of the vehicle body 10 or aircraft fuselage. Only a slight displacement in this z-direction and in the x-direction is here possible, wherein the superconductor 22 is always returned to the stable equilibrium position shown on FIG. 6 in terms of its position relative to the magnet 21. For example, if the position of the superconductor 22 relative to the magnet 21 is deflected by an impact load acting on the primary vehicle structure 11, this impact load is not transmitted directly to the superconductor 22 and hence to the interior vehicle fittings 12, but rather the superconductor 22 is followed up to the relative deflection of the magnet 21 in an dampened, i.e., delayed, manner, wherein the stable state of equilibrium of the superconductor 22 is always assumed relative to the magnet 21 and thus relative to the magnetic field 21a. This means that the more the superconductor 22 is deflected out of the equilibrium position relative to the magnet 21 and the magnetic field 21a, the greater the restoring force that returns the superconductor 22 into the stable equilibrium position illustrated in FIG. 6.

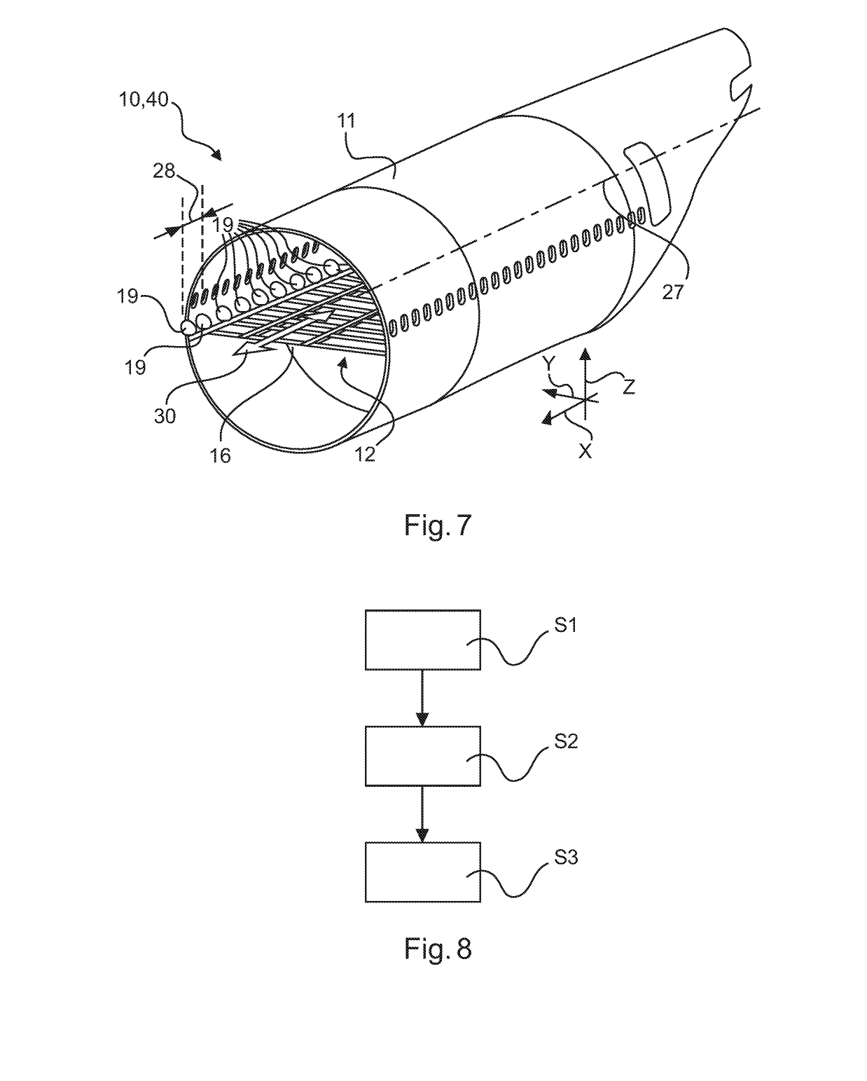

FIG. 7 shows a vehicle body 10, in particular an aircraft fuselage 40, which comprises a primary vehicle structure 11 and interior vehicle fittings 12. The interior vehicle fittings 12 comprises a floor structure 16, in particular a passenger floor of the aircraft fuselage 40. In addition, the aircraft fuselage 40 exhibits a plurality of coupling devices 19, with which the interior vehicle fittings 12 are fastened to the primary vehicle structure 11 without contact.

For example, the coupling devices 19 are spaced apart at prescribed distances 28 parallel to a longitudinal axis 27 of the aircraft fuselage 40, and fastened to the primary vehicle structure 11. To assemble the aircraft fuselage 40, it can be provided that the floor structure 16 is inserted in the longitudinal direction 27, i.e., along the displacement direction 30, into the primary vehicle structure 11, and hence into the aircraft fuselage 40 to be mounted. It can here be provided that the entire interior vehicle fittings 12 is inserted in the displacement direction 30 into the aircraft fuselage 40. This is enabled by virtue of the fact that the interior vehicle fittings 12 or floor structure 16 are supported without contact relative to the primary vehicle structure 11 by means of the coupling devices 19. As a consequence, the floor structure 16 is inserted like a drawer in the displacement direction 30 along the longitudinal direction 27 of the aircraft fuselage 40. During insertion along the displacement direction 30, the magnetic fields generated by the individual coupling devices 19 can provide a force transmission in the y- and z-directions, wherein a force transmission in the x-direction is prevented. This permits a displacement in the displacement direction 30. After assembly or insertion of the interior vehicle fittings 12 into the primary vehicle structure 11, the x-direction can also be blocked by correspondingly adjusting the magnetic field 21a, thereby enabling a force transmission in the x-direction between the interior vehicle fittings 12 and primary vehicle structure 11. By proceeding in this way, prefabricated interior vehicle fittings 12 can be inserted as a complete unit into the primary vehicle structure 11, which is formed by stiffening elements like frames, stringers and outer skin panels, for example, making it possible to significantly reduce the assembly time for the entire aircraft fuselage 40.

FIG. 8 shows a flowchart for a method for assembling a vehicle fuselage 10. In a step S1 of the method, a primary vehicle structure 11 and interior vehicle fittings 12 are provided. In a further step S2, a coupling device 19 is provided for generating a magnetic field 21a. A further step S3 involves displacing the interior vehicle fittings 12 relative to the primary vehicle structure 11 along a longitudinal direction 27 of the vehicle fuselage 10 to be mounted or along a displacement direction 30, wherein the interior vehicle fittings 12 are guided by the magnetic field 21a without contact during displacement relative to the primary vehicle structure 11.

In addition, let it be noted that “comprising” does not preclude any other elements or steps, and “a” or “an” do not rule out a plurality. Let it further be noted that features or steps that were described with reference to one of the above exemplary embodiments can also be used in combination with other features or steps in other exemplary embodiments described above. Reference numbers in the claims are not to be regarded as a limitation.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A vehicle body comprising:
a primary vehicle structure;
a plurality of interior vehicle fittings;
a coupling device for fastening the plurality of interior vehicle fittings to the primary vehicle structure;
wherein the coupling device is configured to generate a magnetic field, so as to fasten the plurality of interior vehicle fittings to the primary vehicle structure without contact.

2. The vehicle body (10) of claim 1,
wherein the coupling device comprises a magnet and a superconducting material, and
wherein the magnet and superconducting material are configured to keep the interior vehicle fittings in a suspended state relative to the primary vehicle structure.

3. The vehicle body of claim 2, wherein the magnet is mounted to the primary vehicle structure; and/or
wherein the superconducting material is mounted to the plurality of interior vehicle fittings.

4. The vehicle body of claim 1, wherein the coupling device comprises a plurality of magnets arranged at prescribed distances parallel to a longitudinal axis of the vehicle body and fastened to the primary vehicle structure.

5. The vehicle body of claim 1, wherein the coupling device comprises a cooling unit configured to cool at least a portion of the coupling device to a cryogenic temperature range.

6. The vehicle body of claim 1, wherein the interior vehicle fittings comprise a floor structure for accommodating goods to be transported inside of the vehicle body.

7. The vehicle body of claim 1, wherein the coupling device is configured to position the interior vehicle fittings relative to the primary vehicle structure by controlling the magnetic field.

8. The vehicle body of claim 1, wherein the coupling device is configured to transmit forces in a x-direction, in a y-direction and in a z-direction of the vehicle body.

9. The vehicle body of claim 1, wherein the vehicle body is an aircraft fuselage.

10. A method for assembling a vehicle body, comprising the steps:
providing a primary vehicle structure and a plurality of interior vehicle fittings;
providing a coupling device for generating a magnetic field;
displacing the plurality of interior vehicle fittings relative to the primary vehicle structure along a longitudinal direction of the vehicle body to be mounted, wherein the plurality of interior vehicle fittings are guided by the magnetic field without contact during displacement along the primary vehicle structure.

11. An edifice, comprising
a load-bearing structure;
a plurality of interior fittings;
a coupling device for fastening the plurality of interior fittings to the load-bearing structure;
wherein the coupling device is configured to generate a magnetic field, so as to fasten the plurality of interior fittings to the load-bearing structure without contact.
